(19) United States
(12) Patent Application Publication
(10) Pub. No.: US 2017/0106543 A1
(43) Pub. Date: Apr. 20, 2017

(54) JOINT MECHANISM FOR HUMANOID ROBOT

(71) Applicant: NABTESCO CORPORATION, Tokyo (JP)

(72) Inventors: Kiyoshi ANDOH, Mie (JP); Hongyou WANG, Mie (JP); Yoshiaki MAKIZOE, Mie (JP); Hideshi SHIMADA, Mie (JP); Takayuki HASE, Mie (JP)

(21) Appl. No.: 15/128,292

(22) PCT Filed: Mar. 19, 2015
(86) PCT No.: PCT/JP2015/058347

§ 371 Date: Sep. 22, 2016

(30) Foreign Application Priority Data
Apr. 3, 2014 (JP) 2014-077217

(51) Int. Cl. B25J 17/02; F16H 1/32; B25J 9/10

(52) U.S. Cl. CPC B25J 17/0241; B25J 9/102; F16H 1/32; Y10S 901/25; Y10S 901/28; F16H 2001/323

(57) ABSTRACT

A joint mechanism includes: a first member; a second member; and a gear device that is provided between the first member and the second member and changes the number of revolutions at a predetermined ratio to transmit a drive force. The gear device includes a crank shaft on which a first eccentric portion is formed, a first oscillating gear that has first external teeth and an insertion hole into which the first eccentric portion is inserted, a carrier that retains the crank shaft rotatably, and an external cylinder that has an internal-tooth pin 3. The carrier and the external cylinder are configured to be displaced coaxially and relatively to each other due to oscillation of the first oscillating gear.

### TECHNICAL FIELD

The present disclosure relates to a humanoid robot joint mechanism.

### BACKGROUND

There has been known a humanoid robot joint mechanism in which a first member is rotatable relative to a second member with a reducer interposed therebetween. Patent Document 1 disclosed a joint mechanism with a harmonic Drive™ which is a strain wave gearing that serves as a reducer disposed between an upper-half torso and a lower-half torso. In this joint mechanism, the strain wave gearing includes an annular internal-tooth gear which is a fixed gear and an elastic external-tooth gear that meshes with the annular internal-tooth gear to rotate and serves as an output gear. An upper shaft of the lower-half torso is fixed to the annular internal-teeth gear and a torso cover of the upper-half torso is fixed to the elastic outer-teeth gear thereby making the upper-half and lower-half torsos rotatable relative to each other.

In recent years, it is desired to enhance an efficiency to transmit a torque from the reducer to the first or second member in the humanoid robot joint mechanism. However, Patent Literature 1 adopts the strain wave gearing that cannot bear a high load as a reducer. In the above-mentioned strain wave gearing, since the output gear is the thin elastic external-tooth gear that is elastically deformable and the size of the teeth of the elastic external-tooth gear is made relatively small in order to obtain a high reduction ratio, there is a possibility that teeth skipping or buckling of the gear is caused by external shock. Consequently the efficiency to transmit the torque may be decreased.

### RELEVANT REFERENCES

### Patent Literature

Patent Literature 1: Japanese Patent Application Publication No. 2005-161438

### SUMMARY

One object of the disclosure is to provide a humanoid robot joint mechanism that overcomes the above-mentioned drawback.

According to one aspect of the invention, a joint mechanism of a humanoid robot includes: first member that forms a first region of the humanoid robot; a second member that forms a second region of the humanoid robot; and a gear device that is provided between the first member and the second member and changes the number of revolutions at a predetermined ratio to transmit a drive force. The gear device includes a crank shaft on which an eccentric portion is formed, an oscillating gear that has external teeth and an insertion hole into which the eccentric portion is inserted, a carrier that retains the crank shaft rotatably and is attached to the second member, and an external cylinder that is disposed on radially outer side of the carrier, has internal teeth meshing with the external teeth of the oscillating gear, and is attached to the first member. The carrier and the external cylinder are configured to be displaced coaxially and relatively to each other due to oscillation of the oscillating gear that is generated by rotation of the crank shaft.

### BRIEF DESCRIPTION OF THE DRAWINGS

FIG. 1 is a schematic elevation view of a humanoid robot according to an embodiment.

FIG. 2 is a schematic sectional view of a main portion of a joint mechanism Y1 according to the embodiment.

FIG. 3 is a schematic side view of a gear device viewing from an end plate side and illustration of a portion of the end plate is omitted.

FIG. 4A is a schematic enlarged sectional view of a fixing area between a one-side fixing member and a shaft in the joint mechanism Y1 according to the embodiment.

FIG. 4B is a schematic enlarged sectional view of a fixing area between an other-side fixing member and a shaft in the joint mechanism Y1 according to the embodiment.

FIG. 5 illustrates Modification Example 1 of the joint mechanism Y1 according to the embodiment showing the same portion as FIG. 2.

FIG. 6 illustrates Modification Example 2 of the joint mechanism Y1 according to the embodiment showing the same portion as FIG. 2.

FIG. 7 illustrates Modification Example 3 of the joint mechanism Y1 according to the embodiment showing the same portion as FIG. 2.

FIG. 8 illustrates Modification Example 4 of the joint mechanism Y1 according to the embodiment showing the same portion as FIG. 2.

### DESCRIPTION OF THE EMBODIMENTS

An embodiment of the invention will now be described with reference to the attached drawings. The drawings referred below are given for the purpose of illustration and the main parts are schematically illustrated. Therefore a joint mechanism of a humanoid robot according to the embodiment may include any parts which are not shown in the drawings.

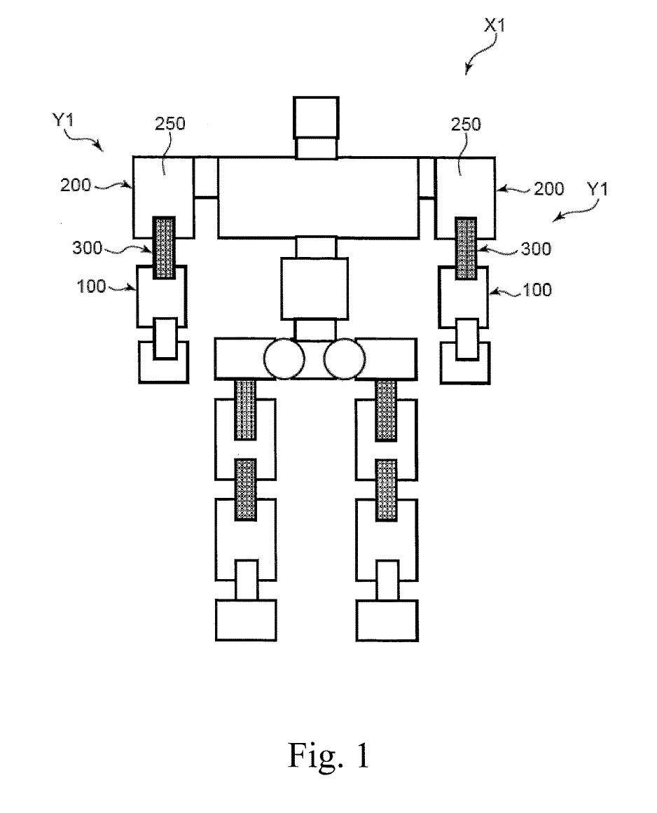

Referring to FIG. 1, the humanoid robot X1 according to the embodiment is a robot with a body shape resemble to the human body and with a plurality of joints. The humanoid robot X1 may include a joint mechanism Y. The joint mechanism Y1 may include a first member 100 that forms a body part from a hand to an elbow, a second member 200 that forms a body part from the elbow to a shoulder, and a gear device 300 that forms the elbow and allows the first member 100 and the second member 200 to rotate relative to each other. The embodiment where the joint mechanism Y1 forms the elbow joint of the humanoid robot X1 will be hereunder described. However, the joint mechanism Y1 may form any other joints of the humanoid robot X1. Moreover, in the embodiment, the joint mechanism Y1 is used for the humanoid robot X1 that has an appearance of human body. However, the invention is not limited to this and the joint mechanism Y1 may also be used for other humanoid robots including one with an appearance of anthropoid ape.

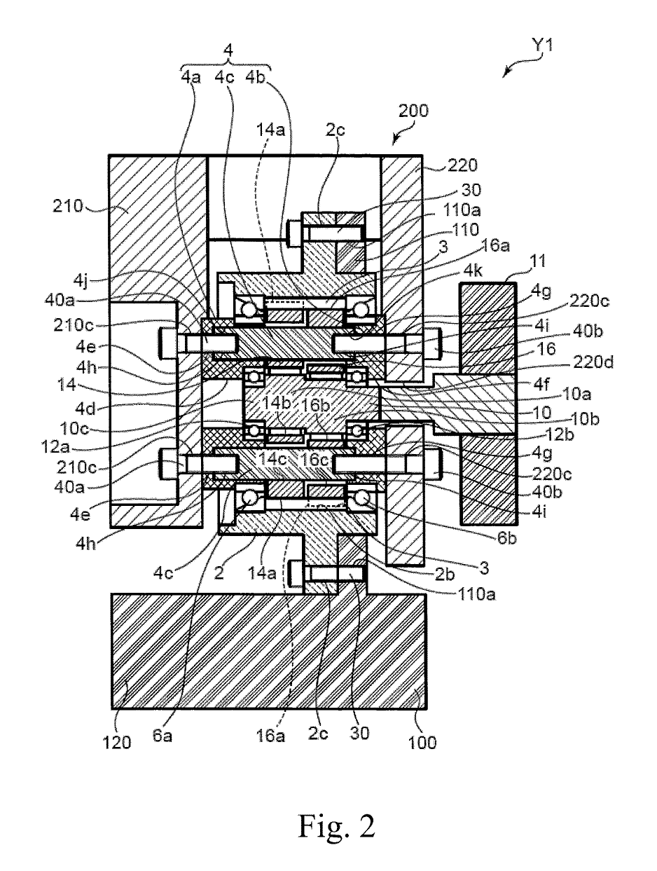

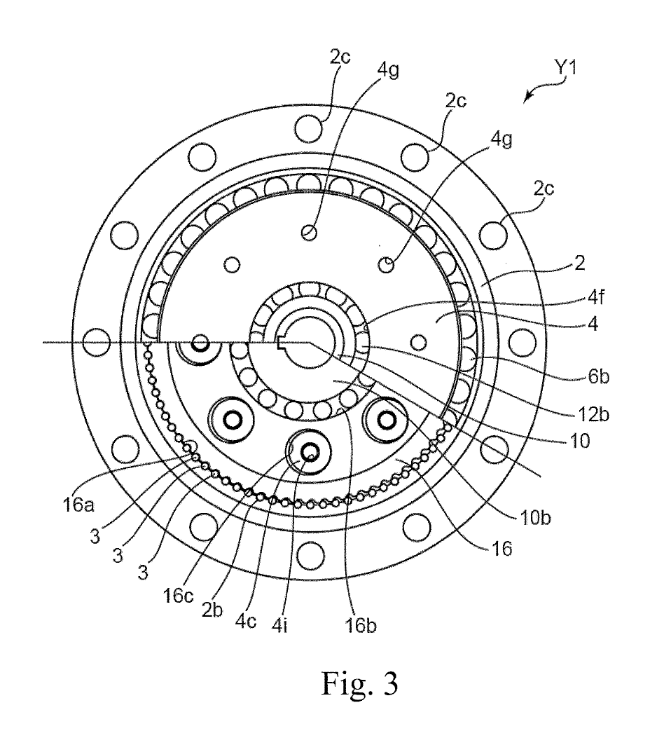

The first member 100, the second member 200, and the gear device 300 included in the joint mechanism Y1 will now be described with reference to FIGS. 2 and 3.

The first member 100 may include a main body 120 and an attachment 110. The main body 120 is a main portion that forms a body part that extends from the hand to the elbow of the humanoid robot X1. The attachment 110 may extend from an edge of the main body 120 into the space between a first portion 210 and a second portion 220 of the second member 200 which will be later described in detail, and may be attached to a hereunder-described external cylinder 2 of the gear device 300.

The second member 200 may include a main body 250, the first portion 210, and the second portion 220. The main body 250 is a main portion that forms a body part that extends from the elbow to the shoulder of the humanoid robot X1. The first portion 210 and the second portion 220 may extend from an edge of the main body 250 toward the first member 100 and face to each other with a gap interposed therebetween.

The gear device 300 is used as a reducer that is provided in an elbow joint of the humanoid robot X1. The gear device 300 may have a reduction ratio, for example, ranging from 80 to 200. The gear device 300 may be disposed in the space between the first portion 210 and the second portion 220 of the second member 200.

The gear device 300 may be a center-crank type gear device. In the gear device 300, a crank shaft 10 disposed at the center of the gear device 300 is rotated in response to input from the outside and oscillating gears 14, 16 are swingably rotated in conjunction with eccentric portions 10a, 10b of the crank shaft 10. In this way, output rotations that are reduced from the input rotations can be obtained. In this manner, the first and second members 100, 200 are rotated relative to each other.

The gear device 300 may include the external cylinder 2, the carrier 4, the crank shaft 10, the first oscillating gear 14, and the second oscillating gear 16.

The external cylinder 2 forms the outer surface of the gear device 300 and has a substantially cylindrical shape. A plurality of pin grooves 2b are formed on an inner periphery of the external cylinder 2. Each pin groove 2b extends in the axial direction of the external cylinder 2 and has a semicircular cross-sectional shape along the plane orthogonal to the axial direction. The pin grooves 2b may be arranged circumferentially along the inner circumferential surface of the external cylinder 2 at a regular interval.

The external cylinder 2 may have a plurality of internal-tooth pins 3. Each internal-tooth pin 3 is attached in the corresponding pin groove 2b. More specifically, each internal-tooth pin 3 is fitted in the corresponding pin groove 2b and retained therein such that it extends in the axial direction of the external cylinder 2. In this manner, the plurality of internal-tooth pins 3 are arranged along the circumference of the external cylinder 2 at a regular interval. The internal-tooth pins 3 may mesh with first external teeth 14a of the first oscillating gear 14 and second external teeth 16a of the second oscillating gear 16.

The external cylinder 2 may have a flange portion that extends radially from the external cylinder 2 toward the outside. The flange portion may be disposed so as to overlap the attachment 110 in the axial direction of the external cylinder 2.

The major portions of the external cylinder 2 except for the internal-tooth pins 3 may be formed of a light-weight material that has a smaller density than that of the internal-tooth pins 3. In this embodiment, the major portions of the external cylinder 2 except for the internal-tooth pins 3 may be formed of aluminum and the internal-tooth pins 3 may be made of ferrous metal.

The carrier 4 may be housed within the external cylinder 2 as it is disposed coaxially with the external cylinder 2. The carrier 4 is disposed on the radially inner side of the external cylinder 2. A pair of main bearings 6a, 6b may be disposed between the carrier 4 and the external cylinder 2 such that they are separated from each other in the axial direction. The main bearings 6a, 6b allow the relative rotations of the external cylinder 2 and the carrier 4.

The carrier 4 may include a basal plate 4a, a plurality of shafts 4c, and an end plate 4b. The basal plate 4a, the shafts 4c, and the end plate 4b may be separate parts. The basal plate 4a and the end plate 4b may be made of a light-weight material with a density smaller than that of the shafts 4c. The shafts 4c may be made of a material with a rigidity higher than that of the basal plate 4a and the end plate 4b. In this embodiment, the basal plate 4a and the end plate 4b may be formed of aluminum and the shafts 4c may be made of ferrous metal. Note that the basal plate 4a, the shafts 4c and the end plate 4b may not be separately provided. For example, the basal plate 4a and the shafts 4a may be integrally formed of the same material and this integrated body and the end plate 4b may be separately provided.

The basal plate 4a may be disposed closer to the first portion 210 in the axial direction within the external cylinder 2. The basal plate 4a may have a circular through-hole 4d at its radial center. The basal plate 4a may abut an inner wall of the first portion 210 in the axial direction of the basal plate 4a.

The basal plate 4a may further have a basal plate concave portion 4j which is a dented portion in the surface of the basal plate 4a that faces the first oscillating gear 14. A plurality of the basal plate concave portions 4j may be provided in the circumferential direction of the basal plate 4a at a regular interval. Each basal plate concave portion 4j holds one end of the corresponding shaft 4c, which will be described later.

The end plate 4b may be disposed in the axial direction of the basal plate 4a at a predetermined distance therefrom and disposed closer to the second portion 220 in the axial direction within the external cylinder 2. The end plate 4b may have a circular through-hole 4f at its radial center. The end plate 4b may abut an inner wall of the second portion 220 in the axial direction of the end plate 4b. The basal plate 4a and the end plate 4b may face to each other with the first and second oscillating gears 14, 16 interposed therebetween.

The end plate 4b may further have an end plate concave portion 4k which is a dented portion in the surface of the end plate 4b that faces the second oscillating gear 16. A plurality of the plate concave portions 4k may be provided in the circumferential direction of the end plate 4b at a regular interval. Each plate concave portion 4k holds the other end of the corresponding shaft 4c, which will be described later.

Each shaft 4c may extend along the axial direction of the basal plate 4a and the end plate 4b and connect the basal plate 4a and the end plate 4b. More specifically, each shaft 4c may be disposed between the basal plate 4a and the end plate 4b and may be inserted into a first through-hole 14c and a second-through hole 16c formed in the first and second oscillating gears 14, 16, which will be later described. The one end of each shaft 4c may be fitted in the corresponding basal plate concave portion 4j of the basal plate 4a, and the other end of each shaft 4c may be fitted in the corresponding plate concave portion 4k of the end plate 4b. In this manner, the shafts 4c are retained by the basal plate 4a and the end plate 4b. The plurality of shafts 4c may be arranged in the circumferential direction of the carrier 4 at a regular interval. The number of the shafts 4c may be adequately changed depending on an application of the gear device 300.

The crank shaft 10 may be disposed such that its shaft center coincides with the axial center of the external cylinder 2 and the carrier 4 in the central region of the gear device 300 and the crank shaft 10 rotates on the shaft center. More specifically, in the central region of the gear device 300, the through-hole 4d in the basal plate 4a, the through-hole 4f in the end plate 4b, a first insertion hole 14b in the first oscillating gear 14, and a second insertion hole 16b in the second oscillating gear 16 which will be later described, are communicated to each other to form a communication hole in which the crank shaft 10 is inserted. At the end portion of the crank shaft 10 situated closer to the second portion 220, provided is an input section 11 such as a pulley to which a drive force generated by an unshown motor is transmitted. More specifically, the input section 11 may be attached to the end portion of the crank shaft 10 via an input hole 220d of the second portion 220 that communicates with the through-hole 4f of the end plate 4b. The input section 11 may transmit the drive force generated by the motor to the crank shaft 10 to rotate the crank shaft 10 on its axis.

The crank shaft 10 may be supported by a pair of crank bearings 12a, 12b such that it is rotatable on its axis relative to the carrier 4. More specifically, the first crank bearing 12a may be disposed between the basal plate 4a and the one end of the crank shaft 10 that is situated close to the first portion 210 in the axial direction of the crank shaft 10. Whereas the second crank bearing 12b may be disposed between the end plate 4b and the other end of the crank shaft 10 that is situated close to the second portion 220 in the axial direction of the crank shaft 10. In this manner, the crank shaft 10 may be rotatably supported by the basal plate 4a and the end plate 4b.

The crank shaft 10 may have a shaft body 10c and the eccentric portions 10a, 10b that are integrally formed with the shaft body 10c. The first and second eccentric portions 10a, 10b may be arranged in the axial direction between the crank bearings 12a, 12b on the shaft body 10c. The first and second eccentric portions 10a, 10b may have columnar shapes and jetty radially outward from the shaft body 10c as they are arranged eccentrically to the center of the shaft body 10c. The first and second eccentric portions 10a, 10b may be arranged on the shaft with predetermined eccentricities from the shaft center and may have a phase difference of a predetermined angle from each other.

The first oscillating gear 14 may be disposed in the space between the basal plate 4a and the end plate 4b inside the external cylinder 2. The first oscillating gear 14 may have an outer diameter slightly larger than the inner diameter of the external cylinder 2. The first oscillating gear 14 may have first external teeth 14a, the first insertion hole 14b and a plurality of the first through-holes 14c. The first external teeth 14a are the wave-shaped portion continuously formed along the entire circumference of the first oscillating gear 14. The number of the first external teeth 14a may be set to a number smaller than the number of the internal-tooth pins 3. The first insertion hole 14b may be a portion where the first eccentric portion 10a is inserted and the first oscillating gear 14 may be attached to the first eccentric portion 10a via a first roller bearing in the first insertion hole 14b. Each of the first through-holes 14c may be a portion where the corresponding shaft 4c is inserted and it may have a diameter slightly larger than the outer diameter of the shaft 4c.

The second oscillating gear 16 may be disposed in the space between the basal plate 4a and the end plate 4b inside the external cylinder 2 and may be situated closer to the second portion 220 compared to the first oscillating gear 14. The second oscillating gear 16 may have an outer diameter slightly larger than the inner diameter of the external cylinder 2. The second oscillating gear 16 may have second external teeth 16a, the second insertion hole 16b and a plurality of the second through-holes 16c. The second external teeth 16a are the wave-shaped portion continuously formed along the entire circumference of the second oscillating gear 16. The number of the second external teeth 16a may be set to a number smaller than the number of the internal-tooth pins 3. The second insertion hole 16b may be a portion where the second eccentric portion 10b is inserted and the second oscillating gear 16 may be attached to the second eccentric portion 10b via a second roller bearing in the second insertion hole 16b. Each of the second through-holes 16c may be a portion where each shaft 4c is inserted and it may have a diameter slightly larger than the outer diameter of the shaft 4c.

The first and second oscillating gears 14, 16 may be swingably rotated in accordance with the eccentric rotations of the first and second eccentric portions 10a, 10b as the crank shaft 10 rotates. More specifically, the first and second oscillating gears 14, 16 may be swingably rotated with a different phase from each other such that the first and second external teeth 14a, 16a mesh with the internal-tooth pins 3.

Although the embodiment adapts the first and second oscillating gears 14, 16 with a different phase, one, three or more oscillating gears may be used.

In the gear device 300 configured as described above, a drive force is transmitted to the crank shaft 10 through the input section 11 and the crank shaft 10 is rotated at a prescribed number of revolution corresponding to the drive force. The first and second oscillating gears 14, 16 are then rotated at a prescribed number of revolutions corresponding to the rotation of the crank shaft 10. At this point, the first and second oscillating gears 14, 16 may mesh with the internal-tooth pins 3 to revolve and their meshing positions may be sequentially displaced. Consequently, the external cylinder 2 and the carrier 4 may be displaced concentrically and relatively to each other.

The gear device 300 may further include a plurality of first fixing members 30 and a plurality of second fixing members 40. The external cylinder 2 may be fixed to the first member 100 by the first fixing members 30, and the carrier 4 may be fixed to the second member 200 by the second fixing members.

Each of the first fixing members 30 is a member to fix the first member 100 to the external cylinder 2. Here, the attachment 110 of the first member 100 may have a plurality of tap holes 110a that penetrate the attachment in the axial direction of the external cylinder 2. The flange portion of the external cylinder 2 may have a plurality of insertion holes 2c that communicate with the corresponding tap holes 110a in the axial direction of the external cylinder 2. The first fixing members 30 may be arranged in the circumferential direction of the external cylinder 2 at a regular interval.

Each first fixing member 30 may be inserted into the corresponding tap hole 110a through the corresponding insertion hole 2c of the flange portion to be fastened to the flange portion in the tap hole 110a and thereby the flange portion and the attachment 110 of the first member 100 are fixed to each other.

Each of the second fixing members 40 is a member that fixes the carrier 4 to the second member 200. The second fixing members 40 may be arranged in the circumferential direction of the carrier 4 at a regular interval. Each second fixing member 40 may include a plurality of one-side fixing members 40a and a plurality of other-side fixing members 40b that face to each other in the axial direction of the carrier 4.

Each of the one-side fixing members 40a is a member that fixes the shaft 4c of the carrier 4 and the basal plate 4a of the carrier 4 to the first portion 210 of the second member 200.

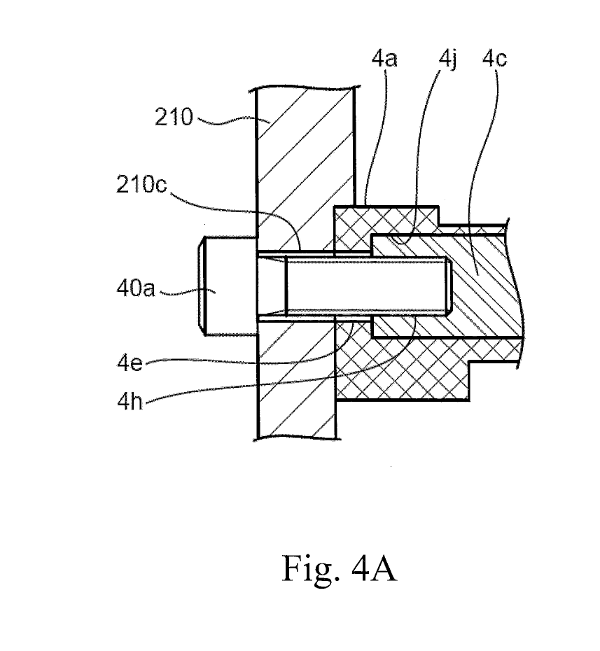

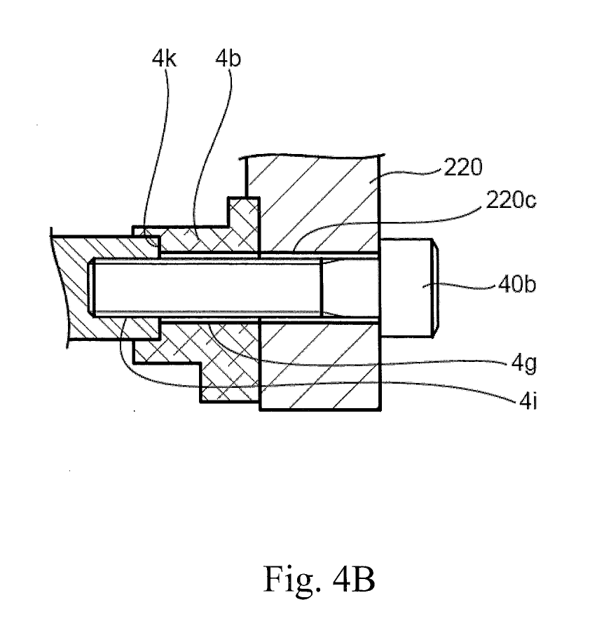

Referring to FIG. 4A, the first portion 210 may have a plurality of insertion holes 210c that penetrate into the carrier 4 in the axial direction. The basal plate 4a may have a plurality of basal plate insertion holes 4e that communicate with the corresponding basal plate concave portions 4j and the corresponding insertion holes 210c in the axial direction of the carrier 4. The one end of each shaft 4c may have a one-side tap hole 4h that communicates with the corresponding basal plate insertion hole 4e in the axial direction of the carrier 4 and that is situated in a dented region of the corresponding basal plate concave portion 4j.

Each one-side fixing member 40a may be inserted into the corresponding one-side tap hole 4h through the corresponding insertion hole 210c and the basal plate insertion hole 4e. Each one-side fixing member 40a is fixed to the one end of the corresponding shaft 4c in the one-side tap hole 4h and thereby the basal plate 4a and the carrier 4 are fixed to the first portion 210.

The basal plate 4a and the carrier 4 may not necessarily be fixed to the first portion 210 by the same one-side fixing member 40a. Alternatively, the shaft 4c and the basal plate 4a may be fixed to each other by one fixing member; and the basal plate 4a and the first portion 210 may be fixed to each other by other fixing member.

Each of the other-side fixing members 40b is a member that fixes the shaft 4c of the carrier 4 and the end plate 4b of the carrier 4 to the second portion 220 of the second member 200.

Referring to FIG. 4B, the second portion 220 may have a plurality of insertion holes 220c that penetrate into the carrier 4 in the axial direction. The end plate 4b may have a plurality of end plate insertion holes 4g that communicate with the corresponding end plate concave portions 4k and the corresponding insertion holes 220c in the axial direction of the carrier 4. The other end of each shaft 4c may have an other-side tap hole 4i that communicates with the corresponding end plate insertion hole 4g in the axial direction of the carrier 4 and that is situated in a dented region of the corresponding end plate concave portion 4k.

Each other-side fixing member 40b may be inserted into the corresponding other-side tap hole 4i through the corresponding insertion hole 220c and the end plate insertion hole 4g. Each one-side fixing member 40b is fixed to the other end of the corresponding shaft 4c in the other-side tap hole 4i and thereby the end plate 4b and the carrier 4 are fixed to the second portion 220.

The end plate 4b and the carrier 4 may not necessarily be fixed to the second portion 220 by the same other-side fixing member 40b. Alternatively, the shaft 4c and the end plate 4b may be fixed to each other by one fixing member, and the end plate 4b and the second portion 220 may be fixed to each other by other fixing member.

A torque transmitted from the crank shaft 10 to the carrier 4 through the first and second oscillating gears 14, 16 are transmitted to the first portion 210 and the second portion 220 through the second fixing members 40 and thereby the second member 200 that is fixed to the carrier 4 by the second fixing members 40 is rotated relatively to the first member 100.

The carrier 4 may not necessarily be fixed to both the first and second portions 210, 220 at each end of the carrier 4 in its axial direction. For instance, when the second member 200 does not include the first portion 210 and the second portion 220 that face to each other, the one-side fixing members 40a may fix the basal plate 4a, the shafts 4c and the second member 200, and the other-side fixing members 40b may fix the end plate 4b and the shaft 4c. In other words, provided that the first member 100 and the second member 200 are rotatable relative to each other, the carrier 4 may be fixed to the second member 200 by the fixing members situated at any positions.

As described above, the joint mechanism Y1 of the humanoid robot X1 according to the embodiment adopts, as the reducer, the gear device 300 in which the carrier 4 and the external cylinder 2 are displaced coaxially and relatively to each other due to the oscillation of the oscillating gears 14, 16 that are rotated by the rotation of the crank shaft 10. In the gear device 300 having such a configuration, the oscillating gears 14, 16 are not deformable macroscopically when the oscillating gears oscillate, and unlike the elastic external-tooth gear in the strain wave gearing, they do not need to be elastically deformable. Moreover, a difference of the number of tooth between the external tooth 14, 16 of the oscillating gears 14, 16 and the internal-tooth pins 3 is set to one(1) in the gear device 300, whereas a difference of the number of tooth between the elastic external-tooth gear and the annular internal-tooth gear in the strain wave gearing is set to two(2) or more. Therefore, the number of the external tooth 14a, 16a in the gear device 300 can be made smaller compared to that of the elastic external-tooth gear in the strain wave gearing, and consequently it is possible to relatively increase the size of each teeth of the external tooth 14a, 16a. Therefore the joint mechanism Y1 of the humanoid robot X1 can prevent teeth skipping or buckling of the gears that may be caused by external shock compared to other humanoid robot joint mechanisms that use the strain wave gearing.

Consequently it is possible to increase the efficiency to transmit the torque. Moreover, in the joint mechanism Y1 according to the embodiment, the basal plate 4a, the end plate 4b, and the shafts 4c may be formed from separate members respectively. Therefore, the joint mechanism Y can be easily assembled. More specifically, when the joint mechanism Y is assembled, firstly the shafts 4c are inserted through the corresponding first through-holes 14c of the first oscillating gear 14 and the corresponding second through-holes 16c of the second oscillating gear 16, and then the basal plate 4a and the end plate 4b are disposed so as to sandwich the first oscillating gear 14 and the second oscillating gear 16. Subsequently, the shafts 4c and the basal and end plates 4a, 4b are connected to each other. In this way, the joint mechanism Y1 may be assembled.

Moreover, in the joint mechanism Y1 according to the embodiment, the shafts 4c to which a high load is applied from the first oscillating gear 14 and the second oscillating gear 16 are made of a rigid material, and the basal plate 4a and the end plate 4b are made of a light-weight material that has a smaller density compared to that of the shafts 4c. Therefore it is possible to reduce the weight of the carrier 4 while maintaining the rigidity of the shafts 4c to which an external force is directly applied from the oscillating gears 14, 16.

In the joint mechanism Y1 according to the embodiment, the one-side fixing members 40a are fastened to the corresponding shafts 4c in the one-side tap holes 4h to fix the basal plate 4a and the shafts 4c to each other. Moreover the other-side fixing members 40 are fastened to the corresponding shafts 4c in the other-side tap holes 4i to fix the end plate 4b and the shafts 4c to each other. Here, a high load tends to be applied to the member in which the tap holes are provided because the member is directly fastened to fixing members when the member is fixed to other member by the fixing members. However, in the joint mechanism Y1, the tap holes 4h, 4i are formed in the shafts 4c that are made of a high-rigidity material compared to the basal plate 4a and the end plate 4b so that it is possible to prevent the carrier 4 from being damaged by the load applied from the one-side fixing members 40a and the other-side fixing members 40b.

Moreover, in the joint mechanism Y1 according to the embodiment, one end of the shaft 4c is fitted in the corresponding basal plate concave portion 4j and the other end of the shaft 4c is fitted in the corresponding end plate concave portion 4k. In this manner, the shafts 4c are retained by the basal plate 4a and the end plate 4b. Therefore it is possible to prevent the shafts 4c from being damaged by loads applied from the one-side fixing members 40a and the other-side fixing members 40b. More specifically, in the embodiment, the one-side tap holes 4h are situated so as to correspond the dented areas of the basal plate concave portions 4j, and the other-side fixing members 40b are situated so as to correspond the dented areas of the end plate concave portions 4k. Therefore one ends and the other ends of the shafts 4c to which loads are directly applied from the one-side fixing members 40a and the other-side fixing members 40b can be effectively retained in the concave portions 4j, 4k.

Furthermore, in the joint mechanism Y1 according to the embodiment, the shafts 4c are fixed to the first portion 210 by the corresponding one-side fixing members 40a that fix the shafts 4c to the basal plate 4a. The carrier 4 is fixed to the second portion 220 by the other-side fixing members 40b that fix the shafts 4c to the end plate 4b. Therefore, it is possible to fix the basal plate 4a, the end plate 4b, the shafts 4c, the first portion 210, and the second portion 220 without increasing the number of components.

Moreover, in the joint mechanism Y1 according to the embodiment, the one-side fixing members 40a that are directly fastened to the corresponding shafts 4c in the one-side tap holes 4h fix the carrier 4 to the first portion 210, and the other-side fixing members 40b that are directly fastened to the corresponding shafts 4c in the tap holes 4i fix the carrier 4 to the second portion 220. Therefore the torque transmitted from the oscillating gears 14, 16 to each shaft 4c is directly transmitted to the corresponding one-side fixing member 40a and the corresponding other-side fixing member 40b. In this way, it is possible to prevent decrease in the transmission efficiency of the torque.

Moreover, in the joint mechanism Y1 according to the embodiment, the two oscillating gears, which are the first oscillating gear 14 and the second oscillating gear 16, are provided. Therefore, for example, comparing with a case where three or more oscillating gears are provided, the weight of the whole gear device 300 can be reduced and consequently it is possible to avoid a heavy weight of the gear device 300 relative to the output torque. Furthermore, comparing with the case where the oscillating gear includes three or more gears, it is possible to further reduce the size of the gear device 300 in the axial direction of the carrier 4.

The embodiment disclosed above is an merely example and the invention is not limited to this. The scope of the invention will be defined by the appended claims not by the above-described embodiment. It is intended to cover modifications and equivalent arrangements that are within the spirit and scope of the appended claims.

For instance, various modifications can be made to the joint mechanism Y1 of the humanoid robot X1 according to the embodiment.

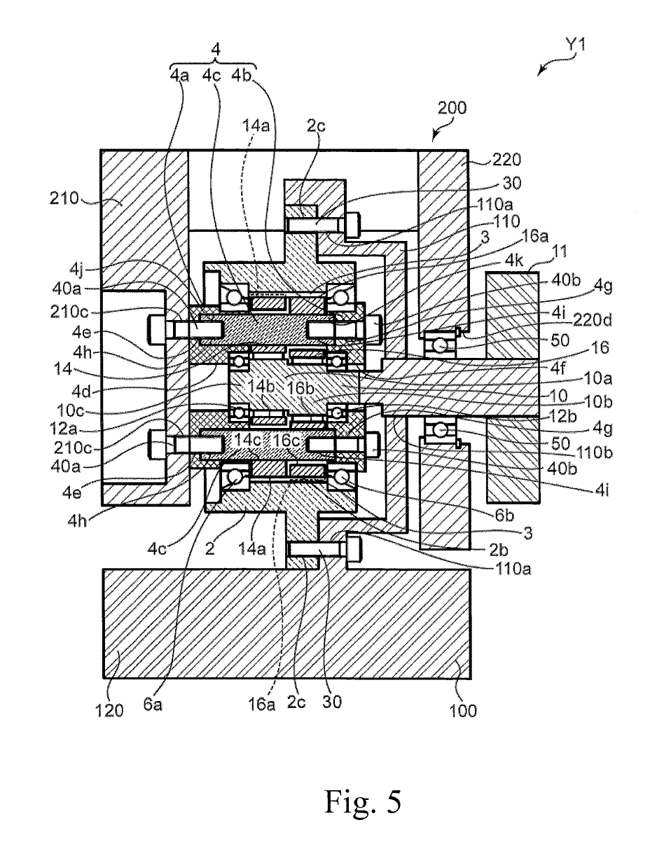

FIG. 5 illustrates Modification Example 1 of the joint mechanism Y1. Referring to FIG. 5, the insertion holes 220c are not provided in the second portion 220 and the other-side fixing members 40b directly fix the corresponding shafts 4c to the end plate 4b. The input section 11 that is attached to the crank shaft 10 through the input hole 220d is supported by a bearing 50 in the input section 11. When the second portion 220 is not fixed to the carrier 4 like this example, by providing the bearing 50 that supports the input section 11 in the input hole 220d of the second portion 220, it is possible to support the gear device 300 at each side of the gear device 300 in the axial direction with the one-side fixing members 40a and the bearing 50.

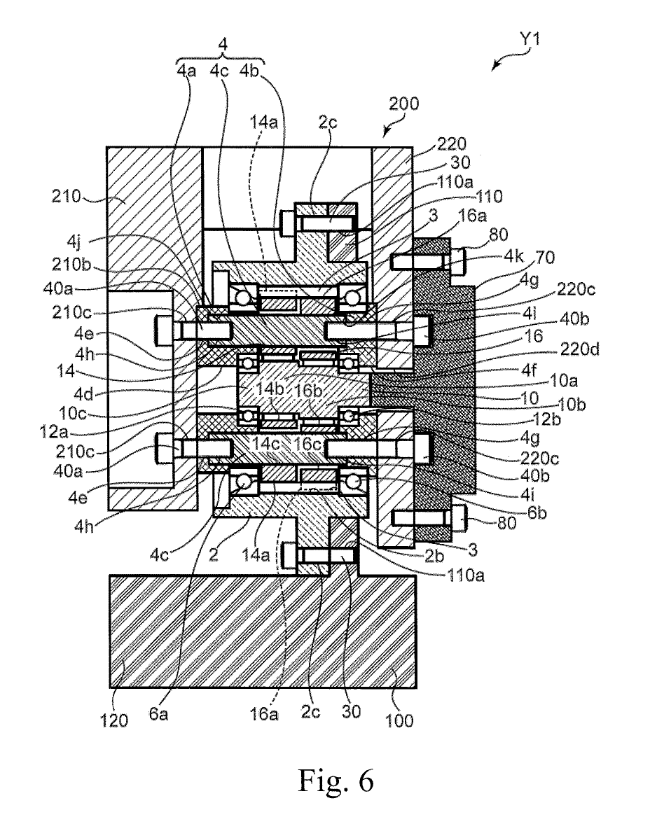

FIG. 6 illustrates Modification Example 2 of the joint mechanism Y1. In Modification Example 3, a flat servo motor 70 is used instead of the input section 11. The flat servo motor 40 is fixed to the second portion 220 by a plurality of forth fixing members 80. The flat servo motor 70 may have a plurality of dents in the surface that faces the external wall of the second portion 220 and each dent receives a screw head of each second fixing member 40. Since the flat servo motor 70 is provided in Modification Example 2 of the joint mechanism Y1 shown in FIG. 6, it is possible to increase the accuracy of the stop position. Moreover, since the flat servo motor 70 is fixed to the second portion 220, the motor that transmit a drive force to the crank shaft 10 can be integrated to the second member 200.

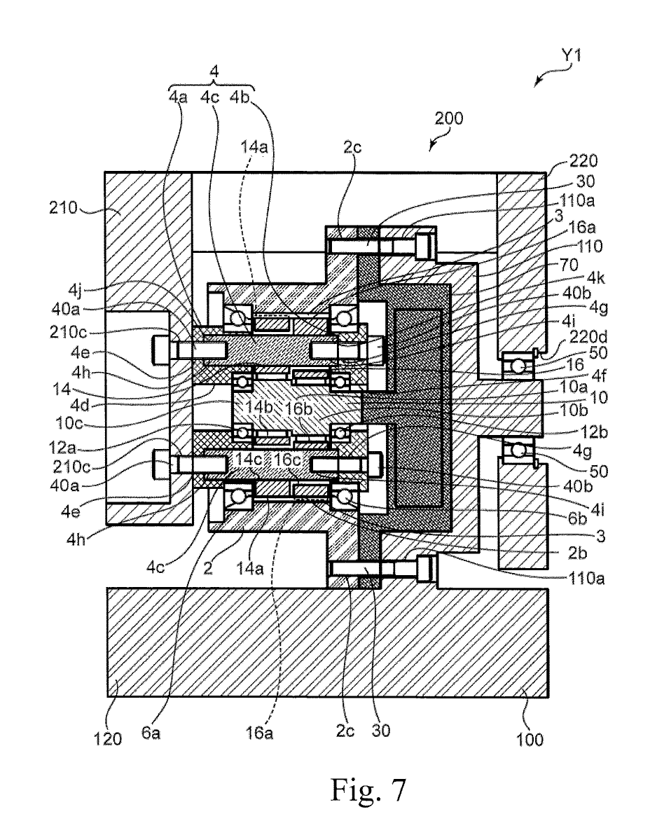

FIG. 7 illustrates Modification Example 3 of the joint mechanism Y1. Referring to FIG. 7, the flat servo motor 70 may be provided between the attachment 110 and the external cylinder 2. Moreover, the flat servo motor 70 may have a hole that is communicated with the insertion hole 2c and the tap hole 110a between the insertion hole 2c and the tap hole 110a. The first fixing member 30 may be inserted into the corresponding tap hole 110a through the insertion hole 2c and the hole of the flat servo motor 70. In this manner, the flat servo motor 70 is fixed to the external cylinder 2 and the attachment 110. In Modification Example 3 of the joint mechanism Y1 illustrated in FIG. 7, the forth fixing members 80 that fix the flat servo motor 70 as illustrated in FIG. 6 are not necessary and therefore the number of components can be reduced.

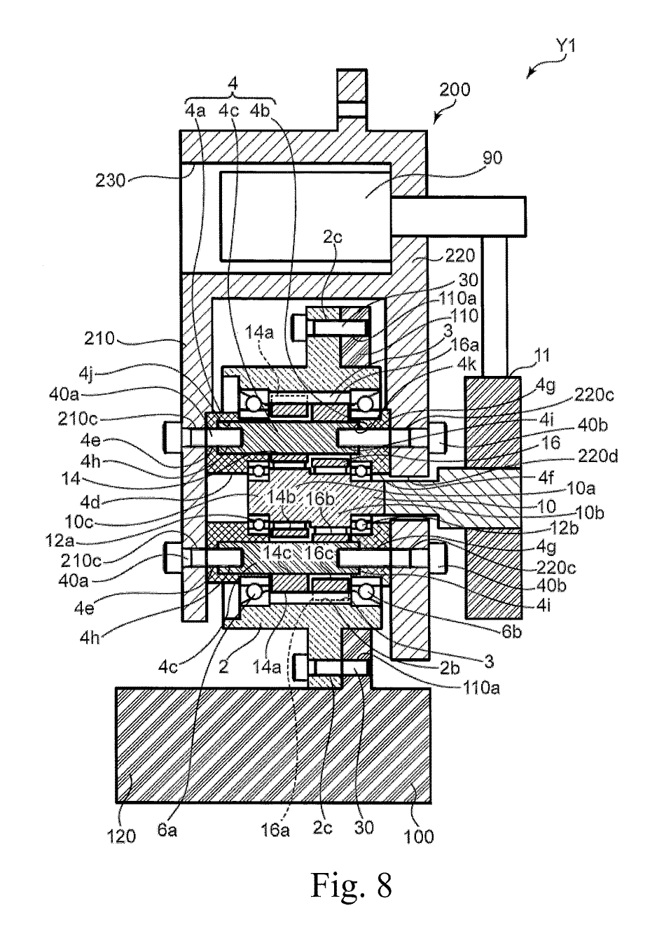

In order to integrate the first member 100 or the second member 200 and the motor that transmit a drive force from the crank shaft 10, in addition to Modification Examples 3, 4 of FIGS. 6, 7, a motor 90 may be housed within a housing 230 provided in the second member 200 and the motor 90 may be coupled to the input section 11 to transmit the drive force from the motor 90 to the crank shaft 10 via the input section 11 as illustrated in Modification Example 4 of FIG. 8.

In Modification Example 4 of the joint mechanism Y1, the motor that provides a drive force to the crank shaft 10 is attached to the first member 100 or the second member 200. In this manner, provided is a module including the first member 100 and the second member 200 that form a part of the humanoid robot X1, the gear device 300 that allows the first member 100 and the second member 200 to rotate relative to each other, and a motor that provides a drive force to the gear device 300. When this module is applied to a pair of joints in the humanoid robot X1, it is possible to improve the efficiency of the assembling process or to reduce the number of components of the humanoid robot X1. The module may also be applied to any other parts in, for example, a pair of hip or knee joints that has a similar axial orientation or positional configuration as the pair of elbows.

The gear device 300 used in the embodiment and Modification Examples 1-4 of the joint mechanism 300 is a center-crank type gear device in which the shaft line of the shaft body 10c of the crank shaft 10 coincides the central axis line of the gear device 300. However, the invention is not limited to this. For instance, instead of the crank shaft 10, a plurality of crank shafts that are arranged circumferentially and radially in the gear device 300 at a regular interval from the central axis line of the gear device 300 may be provided. Alternatively, in addition to the crank shaft 10, the plurality of crank shafts arranged circumferentially may be provided. The number and arrangements of the crank shaft(s) 10 are not limited and they may be adequately changed in accordance with an application of the gear device 300.

Overview of the embodiment and Modification Examples 1-4 will be now described.

The joint mechanism of a humanoid robot according to the embodiment includes: first member that forms a first region of the humanoid robot; a second member that forms a second region of the humanoid robot; and a gear device that is provided between the first member and the second member and changes the number of revolutions at a predetermined ratio to transmit a drive force. The gear device includes a crank shaft on which an eccentric portion is formed, an oscillating gear that has external teeth and an insertion hole into which the eccentric portion is inserted, a carrier that retains the crank shaft rotatably and is attached to the second member, and an external cylinder that is disposed on radially outer side of the carrier and that has internal teeth meshing with the external teeth of the oscillating gear. The carrier and the external cylinder are configured to be displaced coaxially and relatively to each other due to oscillation of the oscillating gear that is generated by rotation of the crank shaft.

The joint mechanism of the humanoid robot described above adapts, as the reducer, the gear device in which the carrier and the external cylinder are displaced coaxially and relatively to each other due to the oscillation of the oscillating gear that is rotated by the crank shaft. Unlike the elastic external-tooth gear used in the strain wave gearing of Patent Literature 1, the oscillating gear may not be necessarily elastically deformable. Moreover the number of the teeth of the oscillating gear can be made smaller than that of the elastic external-tooth gear of the strain wave gearing described in Patent Literature 1. Therefore it is possible to relatively increase the size of the tooth of the oscillating gear. As a result, the above-described joint mechanism of the humanoid robot can prevent teeth skipping or buckling of the gears that may be caused by external shock compared to the joint mechanisms that use the strain wave gearing described in Patent Literature 1. Consequently it is possible to increase the efficiency to transmit the torque.

Furthermore, it is preferable that the oscillating gear have the through-holes that penetrate the oscillating gear in the axial direction, and the carrier include the basal plate, the end plate that faces the basal plate with the oscillating gear interposed therebetween, and the shafts that connect the basal plate and the end plate through the through-holes. In this case, it is preferable that the basal plate, the end plate, and the shaft be formed from separate members.

The above-described humanoid robot joint mechanism can be easily assembled by inserting the shafts in the through-holes of the oscillating gear, then arranging the basal plate and the end plate so as to sandwich the oscillating gear, and finally connecting the shafts to the basal plate and the end plate. Moreover, in the joint mechanism that has such a configuration, the shaft, the basal plate, and the end plate may be formed from different materials from each other. For instance, the shaft may be formed from a highly rigid material since a high load is applied to the shaft, and the basal plate and the end plate may be formed from a relatively light-weight material. Therefore it is possible to provide the carrier with a high strength and light weight.

Moreover, it is preferable that the shafts be made of a material with a rigidity higher than those of the basal plate and the end plate, and the basal plate and the end plate be made of a light-weight material that has a density smaller than that of the shafts.

In the above-described humanoid robot joint mechanism, the shafts are made of a material that has a rigidity higher than that of the basal plate and the end plate, and the basal plate and the end plate are made of a light-weight material that has a density smaller than that of the shafts. Therefore it is possible to reduce the weight of the whole carrier while maintaining the rigidity of the shafts.

Moreover, it is preferable that the humanoid robot joint mechanism further include the one-side fixing member that fixes the shaft to the basal plate, and the other-side fixing member that fixes the shaft to the end plate. In this case, it is preferable that the shaft have an one end that is situated closer to the basal plate in the axial direction of the oscillating gear and has the one-side tap hole, and the other end that is situated closer to the end plate in the axial direction of the oscillating gear and has the other-side tap hole. Moreover, it is preferable that the basal plate have the basal plate insertion hole that communicates with the one-side tap hole. Moreover, it is preferable that the end plate have the end plate insertion hole that communicates with the other-side tap hole. Furthermore it is preferable that the one-side fixing member be inserted into the one-side tap hole through the basal plate insertion hole and be fixed to the corresponding shaft therein to fix the shaft to the basal plate. It is also preferable that the other-side fixing member be inserted into the other-side tap hole through the end plate insertion hole and be fixed to the shaft therein to fix the shaft to the end plate.

In the humanoid robot joint mechanism according to the embodiment, the one-side fixing member is fastened to the corresponding shaft in the one-side tap hole to fix the basal plate and the shaft. Moreover the other-side fixing member is fastened to the shaft in the other-side tap hole to fix the end plate and the shaft. Here, the member in which the tap hole is provided is a part where is directly fastened to the fixing member so that the member is likely to receive a high load from the fixing member. However, in the humanoid robot joint mechanism described above, since the tap hole is provided in the shaft that is made of a material with a high rigidity compared to the basal and end plates, it is possible to prevent the carrier from being broken by the load applied from the fixing member.

Moreover it is preferable that the basal plate have a basal plate concave portion which is a dented portion in the surface of the basal plate that faces the oscillating gear. It is also preferable that the end plate may further have an end plate concave portion which is a dented portion in the surface of the end plate that faces the oscillating gear. In this case, it is preferable that the one end of the shaft be fitted in the basal plate concave portion and the other end of the shaft be fitted in the end plate concave portion.

In the above-described humanoid robot joint mechanism, one end of the shaft is fitted in the basal plate concave portion and the other end of the shaft is fitted in the end plate concave portion. Since the one and other ends of the shaft to which a load is directly applied from the corresponding fixing member are retained by the basal plate and the end plate respectively in this manner, it is possible to prevent the carrier from being damaged by the load applied from the fixing members.

Furthermore, preferably provided is a motor that is attached to the first member or the second member to transmit a drive force to the crank shaft to rotate the crank shaft.

In the humanoid robot joint mechanism described above, the motor that provides a drive force to rotate the crank shaft is attached to the first member or the second member. In this manner, provided is a module including the first member and the second member that respectively form a part of the humanoid robot, the gear device that allows the first member and the second member to rotate relative to each other, and a motor that provides a drive force to the gear device. When this module is applied to a plurality of joints that have a relatively similar structure to each other, it is possible to improve the efficiency of the assembling process or to reduce the number of components of the humanoid robot. The joints that have a relatively similar structure in the single humanoid robot refers to any joints that have a similar axial orientation or positional configuration from each other and an example of such a joint may include a pair of hip joints, a pair of knee joints, and a pair of elbow joints.

1. A joint mechanism of a humanoid robot, comprising:
a first member forming a first region of the humanoid robot;
a second member forming a second region of the humanoid robot; and
a gear device provided between the first member and the second member, the gear device changing the number of revolutions at a predetermined ratio to transmit a drive force, wherein
the gear device includes a crank shaft on which an eccentric portion is formed, an oscillating gear that has external teeth and an insertion hole into which the eccentric portion is inserted, a carrier that retains the crank shaft rotatably and is attached to the second member, and an external cylinder that is disposed on radially outer side of the carrier, has internal teeth meshing with the external teeth of the oscillating gear and is attached to the first member, and
the carrier and the external cylinder are configured to be displaced coaxially and relatively to each other due to oscillation of the oscillating gear that is generated by rotation of the crank shaft.

2. The joint mechanism of a humanoid robot according to claim 1, wherein the oscillating gear has a through-hole that penetrates the oscillating gear in its axial direction,
the carrier includes a basal plate, an end plate that faces the basal plate with the oscillating gear interposed therebetween, and a shaft that connects the basal plate and the end plate through the through-hole, and
the basal plate, the end plate, and the shaft are formed from separate members.

3. The joint mechanism of a humanoid robot according to claim 2, wherein
the shaft is made of a material that has a rigidity higher than those of the basal plate and the end plate, and
the basal plate and the end plate are made of a light-weight material that has a density smaller than that of the shaft.

4. The joint mechanism of a humanoid robot according to claim 3, further comprising
a one-side fixing member that fixes the shaft to the basal plate; and
an other-side fixing member that fixes the shaft to the end plate, wherein
the shaft has an one end that is situated closer to the basal plate in the axial direction of the oscillating gear and has a one-side tap hole, and an other end that is situated closer to the end plate in the axial direction of the oscillating gear and has an other-side tap hole,
the basal plate has a basal plate insertion hole that communicates with the one-side tap hole,
the end plate has an end plate insertion hole that communicates with the other-side tap hole,
the one-side fixing member is inserted into the one-side tap hole through the basal plate insertion hole and fastened to the shaft therein to fix the shaft to the basal plate, and
the other-side fixing member is inserted into the other-side tap hole through the end plate insertion hole and fastened to the shaft therein to fix the shaft to the end plate.

5. The joint mechanism of a humanoid robot according to claim 4, wherein
the basal plate has a basal plate concave portion that is a dented portion in a surface of the basal plate that faces the oscillating gear,
the end plate has an end plate concave portion that is a dented portion in a surface of the end plate that faces the oscillating gear, and
the one end of the shaft is fitted in the basal plate concave portion and the other end of the shaft is fitted in the end plate concave portion in the axial direction of the oscillating gear.

6. The joint mechanism of a humanoid robot according to claim 1, further comprising:
a motor attached to the first member or the second member to transmit a drive force to the crank shaft to rotate the crank shaft.
